(19) United States
(12) Patent Application Publication
(10) Pub. No.: US 2008/0087743 A1
(43) Pub. Date: Apr. 17, 2008

(54) Rotary sprinkler

(75) Inventors: Erez Govrin, Mobile Post Hefer (IL); Yair Shomer, Pardes Hanna (IL)

Correspondence Address: THE NATH LAW GROUP, 112 South West Street, Alexandria, VA, 22314, US

(73) Assignee: NETAFIM LTD, Tel Aviv (IL)

(21) Appl. No.: 11/907,177

(22) Filed: Oct. 10, 2007

(30) Foreign Application Priority Data
Oct. 15, 2006 (IL) 178573

(51) Int. Cl. B05B 3/04

(52) U.S. Cl. 239/214.13; 239/222.11

(57) ABSTRACT

A rotary sprinkler having a longitudinal axis and comprising a housing comprising an upper housing and a lower housing, a nozzle adapted for being brought into fluid communication with a water source and to produce an axial water jet, said nozzle being movable along the axis between a lowered position and a raised position, and a diverter assembly adapted for receiving said water jet from the nozzle and laterally redirecting it. The diverter assembly is movable along the axis with said nozzle between respective inoperative and operative positions of the diverter assembly. The upper housing comprises a nozzle supporting section providing the nozzle with a radial support and an axial support, at least when it is in its raised position.

### FIELD OF THE INVENTION

This invention relates to rotary sprinklers, and more specifically to a bridgeless rotary sprinkler.

### BACKGROUND OF THE INVENTION

Rotary sprinklers are known and widely used for irrigation. A typical rotary sprinkler comprises a body with an axial bore having an inlet and an outlet. The inlet is connectable to a source of pressurized water, e.g. an irrigation hose while the outlet is usually formed as a diverter which re-directs an axially directed water flow into a laterally directed flow. The sprinkler further comprises a driving arrangement to rotate the diverter. Such a driving arrangement may have a speed control mechanism for controlling a desired rotational speed of the diverter. The speed control mechanism may be activated by a turbine mounted on the diverter in such a manner as, on the one hand, to be capable of free rotation, and on the other hand, to cause the diverter to rotate therewith. The turbine may have blades disposed in the path of water exiting the diverter so as to allow the water to impinge the blades, or curved paths for exit of water, thereby imparting a rotational movement to the turbine. Such movement results in a lower rotational speed of the diverter in relation to the turbine and consequently the distribution of the water exiting therefrom in a circular area around the sprinkler.

U.S. Pat. No. 4,754,925 discloses a miniature sprinkler having a fixed, vertically extending nozzle with an inlet and an outlet, the inlet being adapted for communication with a supply pipe. The sprinkler further comprises a flow diverter with an axially extending inlet in register with the outlet of the nozzle, the diverter including bearing means for rotatably mounting the diverter at the top of the nozzle. The inlet in the diverter merges into at least one side outlet which extends generally radially and from which the water is emitted in the form of a jet. The sprinkler further comprises a drive means coupled to the diverter in such a position that at least part of the flow from the diverter outlet impinges on the drive means to cause the rotation of the diverter. In order to reduce the diverter's rotational speed, the drive means includes a turbine rotatably mounted above the diverter for impingement thereon of the flow to cause rapid rotation of the turbine, and a cover member coupled to the diverter and is arranged to be hit intermittently by the turbine, thereby causing rotation of the sprinkler.

In one embodiment of U.S. Pat. No. 4,754,925, when there is no water flowing through the nozzle the diverter drops downwards under its own weight into a cup-shaped member which prevents entry of insects and dirt through the at least one side outlet into the nozzle. However, in a non-upright position of the sprinkler the diverter may remain outside of the cup-shaped member.

U.S. Pat. No. 6,457,656 discloses a below ground pop-up sprinkler that is adapted to rise to a position above a ground surface under high water pressure. Pop-up sprinklers consist of many parts which make these sprinklers expensive and unreliable. These sprinklers operate under high water pressures of typically 35 meters and above therefore require, inter alia, high pressure seals. These seals form high friction with the rising parts of the sprinkler to avoid water leakage and therefore a spring will often be used to retract the pop-up sprinkler down to a closed position below the ground surface.

U.S. Pat. No. 6,899,287 discloses an irrigation sprinkler with two viscous brakes mounted to and which form part of a central rotor. The viscous brakes work in conjunction with each other to maintain a low rotational velocity and also to rotate a water stream diffuser. The water stream is first directed toward a deflector that offsets the stream and angles it toward the area to be watered. The offset stream applies a torsional force on the deflector causing it to rotate. The stream is then interrupted intermittently by the diffuser, attached to the rotor, which is rotating at a different rotational speed. The end result is a sprinkler that rotates slowly and breaks up the stream of water intermittently to create an even pattern of water on the area being sprinkled without using mechanical parts, such as ratchets or gearing.

U.S. Pat. No. 6,883,727 discloses a rotating stream sprinkler of the type having a rotatable deflector for stepwise sweeping of relatively small water streams over surrounding terrain to irrigate adjacent vegetation. The sprinkler includes a turbine driven ball drive rotor having at least one drive ball carried by centrifugal force into repetitious impact engagement with one or more raised anvils on the deflector for incrementally displacing the deflector in a succession of small rotational steps. A speed control brake includes a brake pad interposed between a friction surface on the deflector and a non-rotating brake disk to provide a variable friction force to maintain deflector rotation substantially constant within a range of normal water supply pressures and flow rates.

U.S. Pat. No. 6,814,304 discloses a rotating stream sprinkler of the type having a rotatable deflector for sweeping small streams of irrigation water in a radially outward direction to irrigate adjacent vegetation. The sprinkler includes a speed control brake for maintaining a substantially constant deflector rotational speed throughout a range of normal operating pressures and flow rates. The deflector includes an array of spiral vanes engaged by one or more water jets for rotatably driving the deflector which converts the jets into a plurality of relatively small irrigation streams swept over the surrounding terrain. A friction plate rotatable with the deflector engages a brake pad retained against a non-rotating brake disk. The brake pad includes tapered contact faces for varying the friction contact radius in response to changes in water pressure and/or flow rate to maintain deflector rotational speed substantially constant.

### SUMMARY OF THE INVENTION

According to a first aspect of the present invention, there is provided a rotary sprinkler having a longitudinal axis and comprising a housing including an upper housing and a lower housing; a nozzle adapted to be brought in fluid communication with a pressurized water source and to produce an axial water jet, the nozzle being movable along the axis between a lowered and a raised position; and a diverter assembly adapted for receiving said water jet from said nozzle and laterally redirecting it, the diverter assembly being movable along the axis with the nozzle between the diverter assembly's respective inoperative and operative positions; the upper housing comprises a nozzle supporting section providing the nozzle with a radial support and an axial support, at least when it is in its raised position. The radial and axial supports may be provided at locations spaced from one another.

The upper housing has an upper end and a lower end, the lower end being adapted for mounting the upper housing on the lower housing. The upper housing may further comprise a nozzle spacing extending inwardly and downwardly from the upper end and holding the nozzle supporting section within the lower housing.

The sprinkler may further comprise a cap, which may constitute a part of the diverter assembly and be moveable therewith, to be movable therewith between an open position of the sprinkler, in which the diverter assembly is in its operative position, axially protruding from the upper housing, and a closed position of the sprinkler in which the diverter assembly is in its inoperative position, being received within the upper housing. In the closed position, the cap covers the upper end of the upper housing, thereby preventing access to the diverter assembly in its inoperative position and the nozzle in its lowered position. The upper housing comprises a seat adapted, when the sprinkler is in its closed position, to prevent any part of the cap from projecting laterally from the upper end of the upper housing.

The nozzle supporting section of the upper housing may comprise an aperture for receiving the nozzle such that the aperture's inner walls of may provide the nozzle with said radial support. The nozzle supporting section may further comprise a collar surrounding the aperture, and the collar may provide the nozzle with said axial support.

The sprinkler may further comprise a biasing mechanism adapted for causing a movement of the nozzle from its raised position to its lowered position when no axial force is applied thereto sufficient to bring it to the raised position.

The nozzle may have an upstream end and a downstream end; the diverter assembly being adapted for rotating about the axis and being rotatably mounted to at least the upstream end of the nozzle; the nozzle and diverter assembly having axially extending contacting surfaces.

The diverter assembly may comprise a rotatable diverter adapted for receiving the axial stream of water and laterally redirecting it; a turbine adapted to rotate independently of the diverter and comprising a first drive element and blades positioned to be impacted by at least a portion of the redirected stream of water and being formed such that, when they are impacted by the stream, a rotational force is imparted to the turbine; and a cap adapted to rotate with the diverter and comprising a second drive element positioned so as to be engaged by the first drive element upon rotation of the turbine; wherein the material of the first drive element and/or the second drive element is different from, and better adapted to withstand impacts than, that of the turbine and/or cap, respectively (i.e., at least one of the following is true: (1) the material of the first drive element is different from, and better adapted to withstand impacts than, the material of the turbine; and (2) the material of the second drive element is different from, and better adapted to withstand impacts than, the material of the cap).

According to another aspect of the present invention, there is provided a rotary sprinkler having an axis and comprising a housing including an upper housing and a lower housing; a nozzle adapted for being brought into fluid communication with a water source and for producing an axial water jet and a diverter assembly adapted to receive said water jet and to laterally redirect it. The upper housing has an outer, mounting portion and an inner, nozzle holding portion. The outer mounting portion has an upper end and a lower end, the latter being adapted for mounting the upper housing on the lower housing. The nozzle holding portion extends inwardly and downwardly from the upper end of the outer portion and it has a nozzle supporting section located within the lower housing for axially and radially supporting the nozzle.

The nozzle supporting section may have the same design as that in the sprinkler according to the first aspect of the invention described above.

According to a further aspect of the present invention, there is provided a rotary sprinkler comprising a housing having an open upper end and a lower end, a nozzle adapted for being brought into fluid communication with a water source via said lower end and for producing an axial water jet, the nozzle being movable between a lowered and a raised position; and a diverter assembly axially movable with said nozzle into the diverter assembly's respective inoperative position in which it is received within said housing, and operative position in which it projects upwardly from said open end of the housing. The sprinkler further comprises a cap movable between an open position, associated with the operative position of the diverter assembly and the raised position of the nozzle, and a closed position, associated with the inoperative position of the diverter assembly and the lowered position of the nozzle, wherein the cap, in its open position, covers the upper open end of the housing thereby preventing access to the diverter and the nozzle in their inoperative position. The housing further comprises a seat formed adjacent said upper end thereof adapted, when the cap in its closed position, to prevent any part of the cap from projecting laterally from a top surface thereof.

The cap may constitute a portion of the diverter assembly.

According to a still further aspect of the present invention, there is provided a rotary sprinkler having an axis and comprising a housing and a nozzle having an upstream end and a downstream end and adapted for being brought into fluid communication with a water source and to produce an axial water jet, and a diverter assembly adapted to rotate about the axis and being rotatably mounted to the upstream end of the nozzle and to laterally redirect said water jet. The nozzle and diverter assembly have axially extending contacting surfaces.

According to a still further aspect of the present invention, there is provided a diverter assembly for use in a rotary sprinkler, the diverter assembly comprising a rotatable diverter, a turbine, and a cap. The diverter is adapted for receiving an axial jet of water and laterally redirecting it. The turbine element is adapted to rotate independently of the diverter and comprises blades positioned to be impacted by at least a portion of the redirected stream of water, and a first drive element. The blades are formed such that, when they are impacted by the stream, a rotational force is imparted to the turbine. The cap is adapted to rotate with the diverter and comprises a second drive element positioned so as to be engaged by the first drive element upon the rotation of the turbine. The material of the first drive element and/or the second drive element is different from, and better adapted to withstand impacts than, that of the turbine and/or cap, respectively (i.e., at least one of the following is true: (1) the material of the first drive element is different from, and better adapted to withstand impacts than, the material of the turbine; and (2) the material of the second drive element is different from, and better adapted to withstand impacts than, the material of the cap).

The material of the cap may comprise nylon, which may comprise glass fibers, and the material of said second drive element may comprise a thermoplastic polyurethane elastomer (also know as a TPU).

According to a still further embodiment of the present invention, there is provided a rotary sprinkler adapted to be fully positioned above a ground face, the sprinkler comprising a biasing mechanism and a closable housing defining therein an interior; the sprinkler being adapted to assume an open position in an operative state thereof and a closed position, wherein access to the interior is prevented, in an inoperative state thereof; the biasing mechanism being adapted to bring the sprinkler into its closed position.

It will be appreciated that in the specification and claims, the limitation of “access to the interior is prevented” is not necessarily to be construed to include access to the interior of the sprinkler via a water source, i.e., even in the closed position of the sprinkler, access to the interior of the sprinkler may be permitted via an opening adapted for connecting to a water source.

The sprinkler may have an axis and comprise within the interior a nozzle adapted to be brought into fluid communication with a water source and to produce an axial water jet, the nozzle being movable along the axis between a lowered position and a raised position; and a diverter assembly adapted to receive the water jet from the nozzle and to laterally redirect it; the diverter assembly being movable with the nozzle along the axis between respective inoperative and operative states of the sprinkler, wherein the biasing mechanism is adapted for causing a movement of the nozzle from its raised position to its lowered position when no axial force is applied thereto sufficient to bring it to the raised position.

The sprinkler may further comprise a cap movable between an open position of the sprinkler, wherein the diverter assembly axially protrudes from the housing, and a closed position of the sprinkler, wherein the diverter assembly is received within the housing, wherein it covers an open upper end of the housing thereby preventing access to the interior in the closed position of the sprinkler; the housing comprising a seat adapted, at least when the sprinkler is in its closed position, to prevent any part of the cap from projecting laterally from the housing.

The cap may constitute a part of the diverter assembly and be movable therewith.

The sprinkler may be adapted for being mounted on a riser above the ground face, and may further comprise a speed control mechanism.

The sprinkler may be adapted to be brought into flow communication with a water source being at a local water pressure, the local water pressure being sufficient to urge the sprinkler to assume the open position in the operative state.

The sprinkler may be adapted to assume the open position when in fluid communication with a local water pressure of or greater than 1 meter above atmospheric pressure. Alternatively, it may be adapted to assume the open position when in fluid communication with a local water pressure of or greater than 5 meters above atmospheric pressure.

The rotary sprinkler according to any one of the above aspects of the invention may further comprise a cup-shaped filter surrounding the nozzle.

It will be appreciated that the sprinkler according to the present invention may be embodied by any one or more of the above aspects in combination.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIGS. 1A and 1B are perspective views of a sprinkler according to the present invention in closed and open positions, respectively;

FIG. 2A is a cross-sectional view of the sprinkler as illustrated in FIG. 1A, taken along line II-II in FIG. 1A;

FIG. 2B is a cross-sectional view of the sprinkler as illustrated in FIG. 1B, taken along line III-III in FIG. 1B;

FIG. 2C is a cross-sectional view of an upper housing and a nozzle of the sprinkler illustrated in FIGS. 1A and 1B, when the sprinkler is in its open position;

FIG. 3A is an exploded view of a diverter assembly of the sprinkler illustrated in FIGS. 1A and 1B;

FIG. 3B is an enlarged assembled view of the diverter assembly illustrated in FIG. 3A;

FIG. 3C is a perspective view of a diverter of the diverter assembly illustrated in FIGS. 3A and 3B;

FIG. 3D illustrates the diverter as in FIG. 3C, sectioned along line IV-IV in FIG. 3C;

FIG. 4A is a bottom perspective view of a turbine of the diverter assembly illustrated in FIG. 3A;

FIG. 4B is a top perspective view of a turbine of the diverter assembly illustrated in FIG. 3A;

FIG. 5A is a perspective view of a diverter bracket of the diverter assembly illustrated in FIG. 3A;

FIG. 5B is a perspective cross-sectional view of the diverter bracket as in FIG. 5A, taken along line V-V;

FIG. 6A is a top perspective view of a cap of the diverter assembly illustrated in FIG. 3A;

FIG. 6B is a partial cross-sectional view of the cap in the area of a through-going aperture thereof, taken along line VI-VI in FIG. 6A;

FIG. 6C is a bottom perspective view of the cap illustrated in FIG. 6A;

FIG. 6D is a bottom perspective view of another embodiment of the cap illustrated in FIG. 6C.

FIG. 7A is a perspective view of a nozzle of the sprinkler illustrated in FIGS. 1A and 1B;

FIG. 7B is a perspective cross-sectional view of the nozzle as illustrated in FIG. 7A, taken along line VII-VII;

FIG. 8A is a perspective view of a filter of the nozzle of the sprinkler illustrated in FIGS. 1A and 1B;

FIG. 8B is a perspective cross-sectional view of the filter as in FIG. 8A, taken along line VIII-VIII;

FIG. 9A is a perspective cross-sectional view of a lower housing of the sprinkler illustrated in FIGS. 1A and 1B, taken along its longitudinal axis;

FIG. 9B is a perspective cross-sectional view of an upper housing of the sprinkler illustrated in FIGS. 1A and 1B, taken along its longitudinal axis;

FIG. 9C is a closeup view of the area indicated at B in FIG. 9B;

FIG. 10A is a schematic view of the sprinkler, in a closed position, mounted on a riser; and

FIG. 10B is a schematic view of the sprinkler, in an open position, mounted on the riser.

### DETAILED DESCRIPTION OF EMBODIMENTS

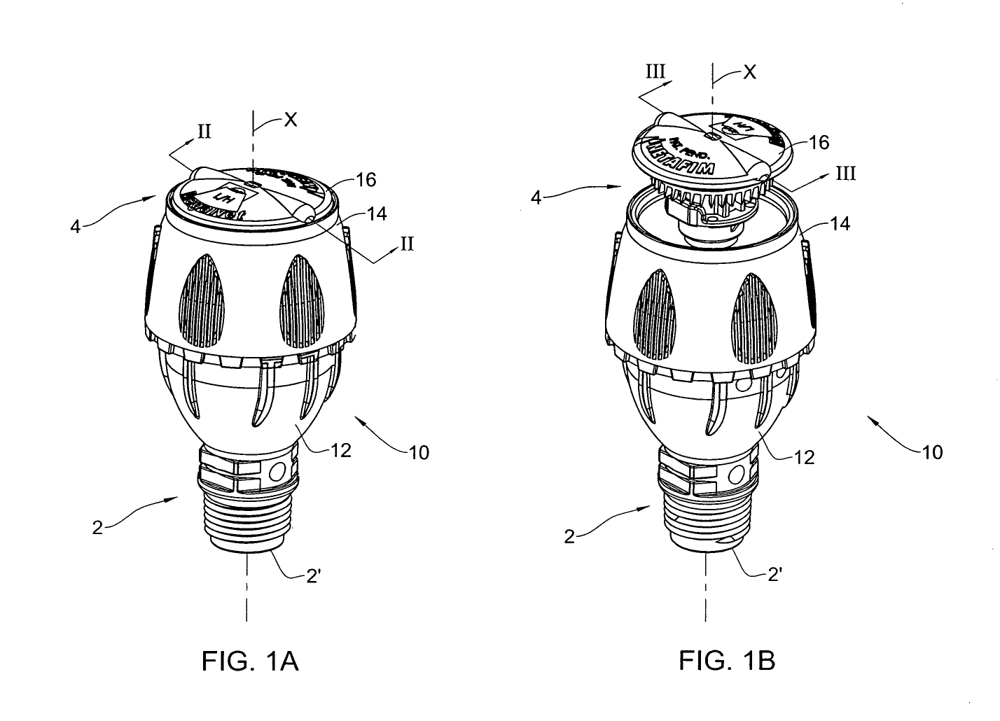

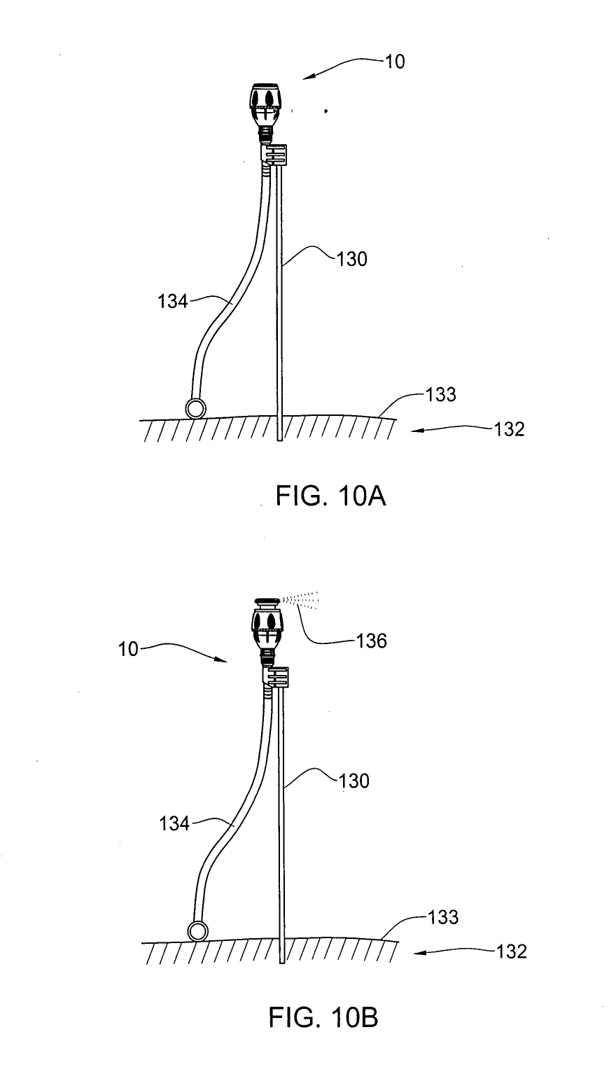

FIGS. 1A and 1B illustrate one example of a sprinkler 10 according to the present invention, in respective closed (i.e., non-operative) and open (i.e., operative) positions. The sprinkler 10 has a longitudinal axis X, an axially extending inlet portion 2 with an inlet end 2′ adapted for fluid communication with a pressurized water source such as an irrigation hose or a riser (see FIGS. 10A and 10B), and an outlet end 4 from where the fluid is sprayed laterally.

In the discussion of the sprinkler, the terms upper, lower, above, below, etc., are used for convenience, and refer to the orientation of the sprinkler as illustrated in the accompanying figures. However, it will be appreciated that the sprinkler, in use, may be mounted in such a way that a portion referred to herein as “upper” is below a portion referred to herein as “lower.” Therefore, the terms “upper” and “lower” are to be understood in their broadest sense as referring to, respectively, upstream and downstream directions of the sprinkler and its constituent elements.

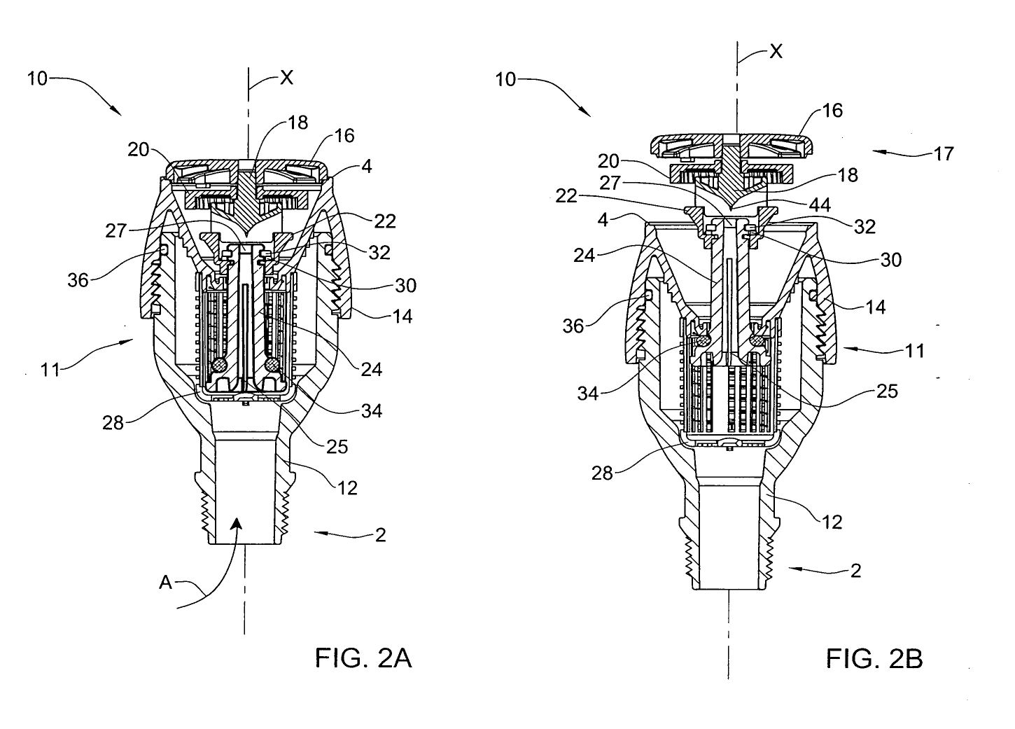

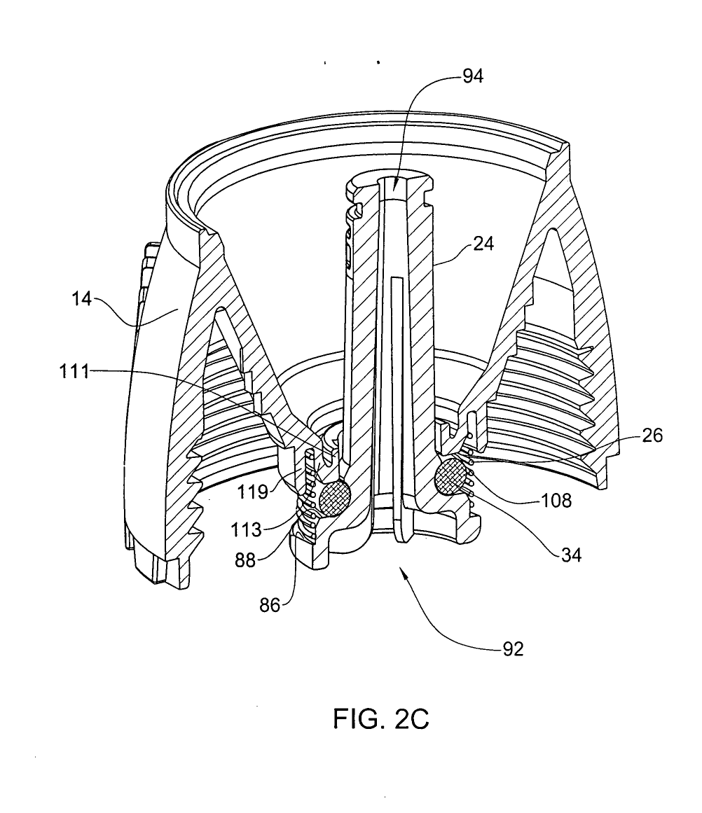

As seen in FIGS. 2A and 2B, the sprinkler 10 comprises a housing assembly generally designated as 11, a nozzle 24, and a diverter assembly generally designated 17 in FIG. 2B.

The housing assembly 11 comprises a lower housing 12 including the inlet end 2′ of the sprinkler, and an upper housing 14 including the outlet end 4 of the sprinkler.

The nozzle 24 has an upstream end 25 in fluid communication with the inlet end 2′ of the sprinkler, and a downstream end 27. The nozzle is axially movable between a lowered position (FIG. 2A), in which the downstream end 27 of the nozzle is inwardly spaced from the outlet end 4 of the sprinkler, and a raised position (FIG. 2B), in which the downstream end 27 of the nozzle is located adjacent the outlet end 4 of the sprinkler.

The diverter assembly 17 is rotatably mounted on the downstream end 27 of the nozzle 24, so that when fluid is supplied into the nozzle and the nozzle takes its raised position (as illustrated in FIG. 2B), the diverter assembly projects from the upper housing 14 and laterally redirects fluid coming from the nozzle, while rotating about the longitudinal axis X of the sprinkler, and when fluid is not supplied into the nozzle and the nozzle takes its lowered position (as illustrated in FIG. 2A), the diverter assembly 17 is received within the upper housing 14.

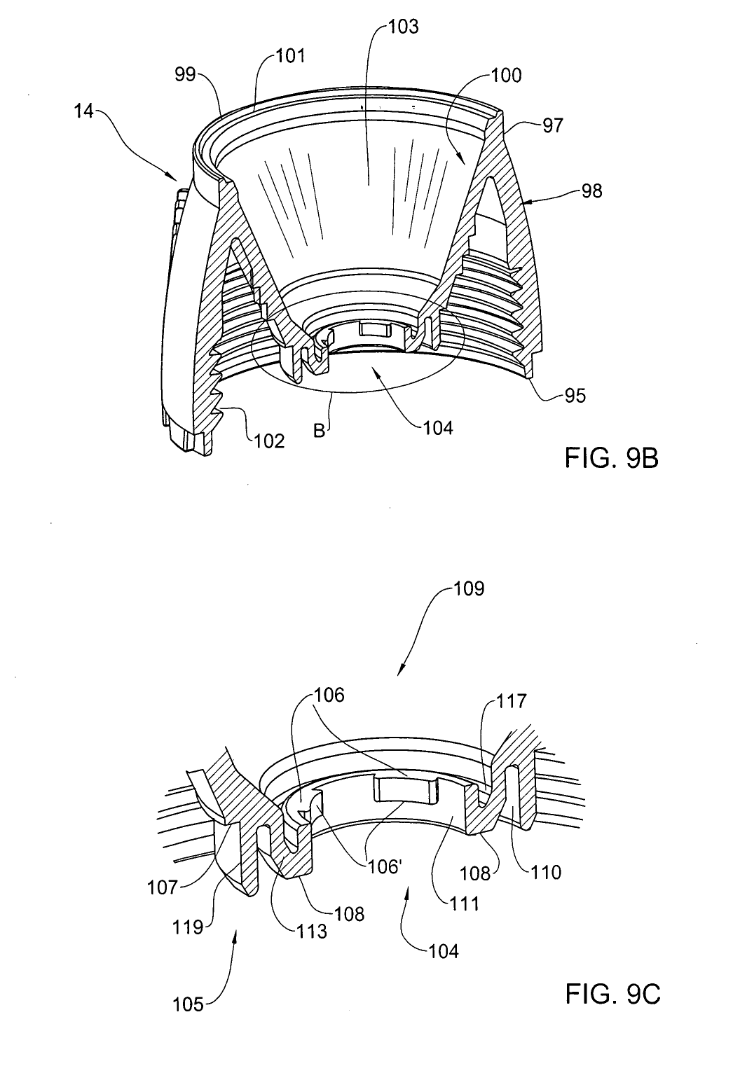

With reference to FIG. 9A, the lower housing 12 comprises a narrow lower portion 120 with a first external threading 124 formed thereon for the attachment of the housing assembly 11 to an irrigation hose or the like, and a wide upper portion 122 formed with a second external threading 126 for the attachment thereto of the upper housing 14. It further comprises an external groove 127 located above the threading 126, adapted to receive therein an O-ring 36, as seen in FIGS. 2A and 2B.

With reference to FIGS. 9B and 9C, the upper housing 14 comprises an outer mounting portion 98 having a lower end 95 and an upper end 97, and an inner, nozzle holding portion 100.

The mounting portion 98 has, at or adjacent its lower end 95, an internal threading 102 adapted for cooperation with the threading 126 of the lower housing 12 and, at its upper end 97, a circumferential rim 99 formed with a seat 101 slightly projecting therefrom into the interior of the upper housing 14.

The nozzle holding portion 100 has a nozzle spacing section 103 converging inwardly and downwardly from the upper end 97 of the upper housing 14, a cylindrical nozzle supporting section 109 (best seen in FIG. 9C), and a transition step 107 therebetween.

As best seen in FIG. 9C, the nozzle supporting section 109 has a nozzle receiving aperture 104 with a collar 105 surrounding it. The collar 105 has an innermost wall 111 formed with several nozzle supports 106 radially projecting into the nozzle receiving aperture 104 and having inwardly facing curved sides 106′ which define therebetween an imaginary circle of a diameter D (not shown). The collar 105 also has an intermediate wall 113 and a flange 108, at which both the innermost and intermediate walls 111, 113 terminate. The collar 105 further has an upwardly (i.e., downstream) open groove 117 formed between the two walls 111, 113, and providing the wall 111 with a desired flexibility. The collar 105 has a cylindrical outermost wall 119 and a downwardly (i.e., upstream) open circumferential channel 110 formed between the outmost wall 119 and the intermediate wall 113, and providing the outermost wall 119 with a desired flexibility.

With reference to FIGS. 7A and 7B, the nozzle 24 comprises a base portion 80 including the upstream end 25 of the nozzle, and an axially extending tube portion 81 upwardly protruding therefrom and including the downstream end 27 of the nozzle. The tube portion 81 has a top end portion 81′ formed with a peripheral groove 84 for mounting the diverter assembly 17 thereon, and a bottom end portion 81″ merging with the base portion 80. The tube portion 81 slightly tapers from its bottom end portion 81″ to its top end portion 81′, and its diameter at the area of the bottom end portion 81″ is equal to the diameter D mentioned above with reference to FIGS. 9B and 9C, allowing this area to be received in the nozzle receiving aperture 104 of the upper housing 14, snuggly fitting the nozzle supports 106, of the nozzle supporting section 109. The base portion 80 of the nozzle is bi-level, giving rise to an outer seat 86 and an inner seat 88.

The nozzle 24 is formed with a central through-going fluid passageway 90 having an inlet 92 at the upstream end 25 and an outlet 94 at the downstream end 27 of the nozzle, and tapering in the direction towards the outlet 94. The passageway 90 is formed with inwardly projecting ribs 96 extending upwardly from the inlet 92 along the majority of the length of the passageway 90 and having a radial extension gradually decreasing in the direction away from the inlet 92. The ribs are formed so as to stabilize and direct the axial flow of liquid through the passageway 90.

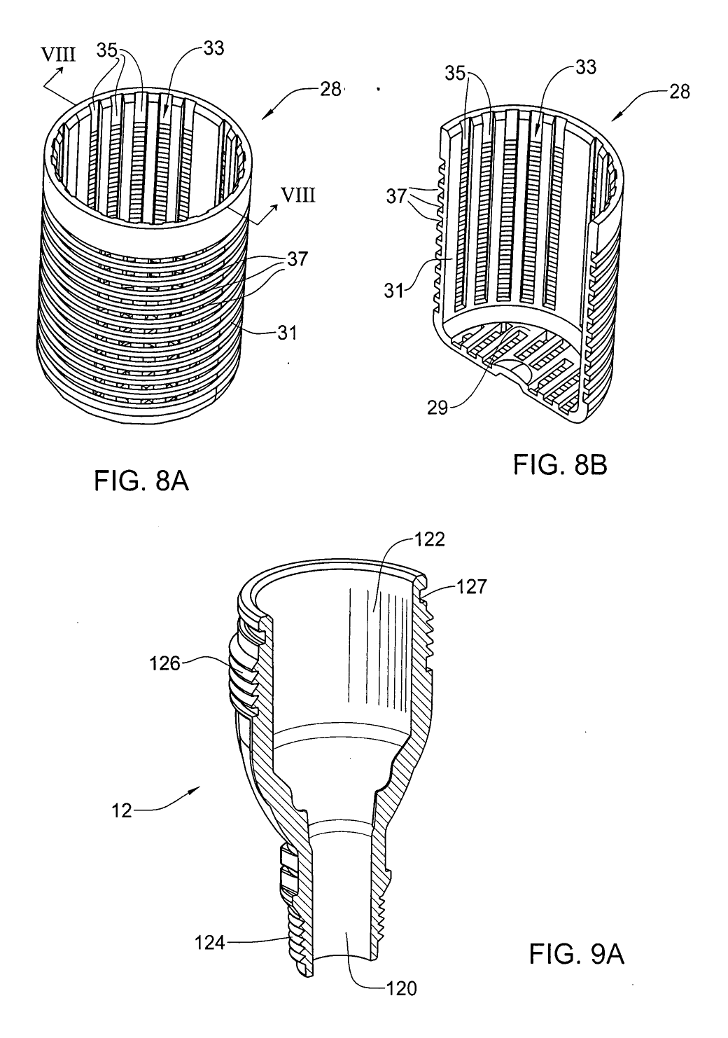

Reverting to FIGS. 2A and 2B, the sprinkler 10 further comprises a filter 28 better seen in FIGS. 8A and 8B, which has a bottom wall 29, a cylindrical side wall 31 and an open top 33. The bottom and side walls 29, 31 of the filter 28 are formed with a plurality of filter openings defined at the intersection of a plurality of elongated axial slots 35 with a plurality of circumferential grooves 37, for filtering fluid entering the upstream end 25 of the nozzle 24. Referring to FIGS. 1A and 1B, the filter 28 has such a height as to allow the nozzle 24 to move axially within the filter between its lowered position (FIG. 1A) in which the upstream end 25 of the nozzle rests on the bottom wall 29 of the filter, and its raised position, in which the upstream end 25 of the nozzle is disposed closer to the top 33 than to the bottom wall 29 of the filter.

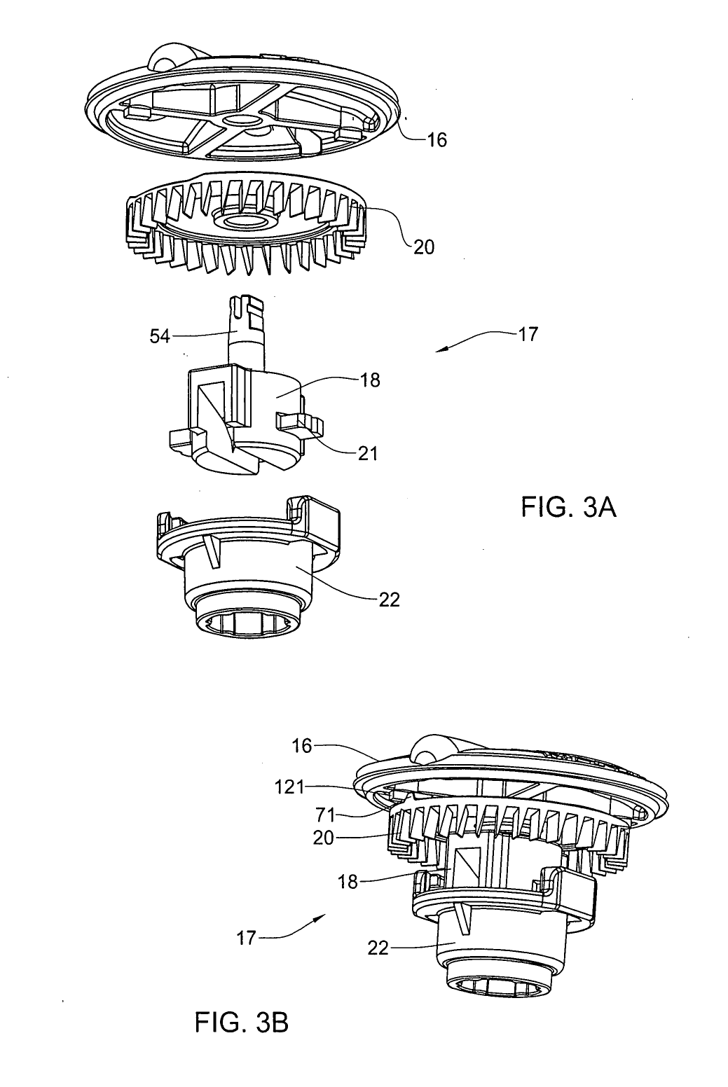

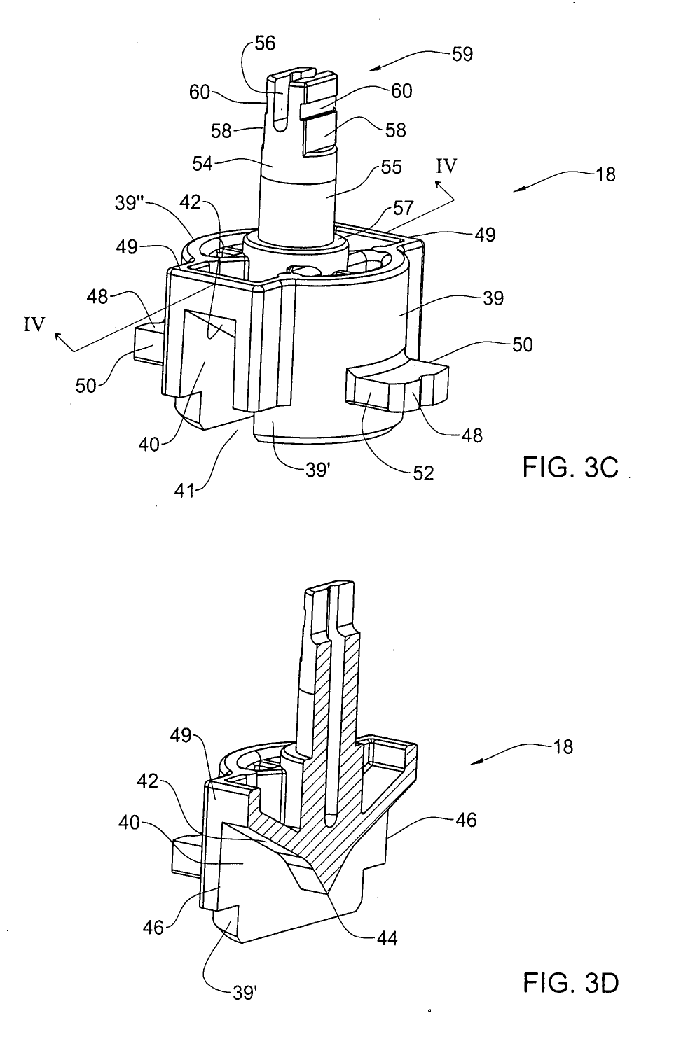

Reverting to FIGS. 2A and 2B, the diverter assembly 17 will now be described, whose exploded view is shown in FIG. 3A and enlarged assembled view is shown in FIG. 3B. The diverter assembly 17 comprises a diverter 18, a diverter bracket 22, a turbine 20 and a cap 16. The diverter 18 has an axially extending shaft 54 for mounting thereon the turbine 20 and the cap 16 and a bracket engaging portion 21 for the attachment of the diverter 18 to the diverter bracket 22. The diverter bracket 22 is adapted to hold the diverter 18 and to be rotatably mounted together therewith on the top end portion 81′ of the tube portion 81 of the nozzle 24. All these components of the diverter assembly 17 will now be described in more detail.

As seen in FIGS. 3C and 3D, the diverter 18 comprises a cylindrical diverter body 39 having a lower end 39′ and an upper end 39″ from which the shaft 54 projects. The lower end 39′ of the diverter body 39 is formed with an inlet 41 merging into two diametrically opposed slots 40 (only one visible in FIG. 3C) which are open downwardly (i.e., upstream) and outwardly. The slots 40 have diverting walls 42 merging at a central rib 44 and extending radially and upwardly (i.e., downstream) from this rib. The diverter body 39 is formed with radially protruding outlets 49 at which the slots 40 terminate. The diverter body 39 is further formed with wings 48 projecting from opposite sides thereof and located between the outlets 49. Each wing 48 is tapered such that it is wider at a trailing end 50 thereof than at a leading end 52. The outlets 49 and the wings 48 are all spaced from the lower end 39′ of the diverter body 39 so that the latter is smooth along the entire circumference of its area adjacent the lower end 39′.

The shaft 54 has a bottom section 55 with a seat 57 for mounting thereon the turbine 20, and a top section 59 for mounting thereon the cap 16. The top section 59 comprises an upwardly open slot 56 and planar side surfaces 58 on two sides of the slot 56, which are parallel to the slot, at least in their regions co-extensive with the slot. The side surfaces 58 are each formed with a cap engaging groove 60 extending perpendicular to the shaft's height.

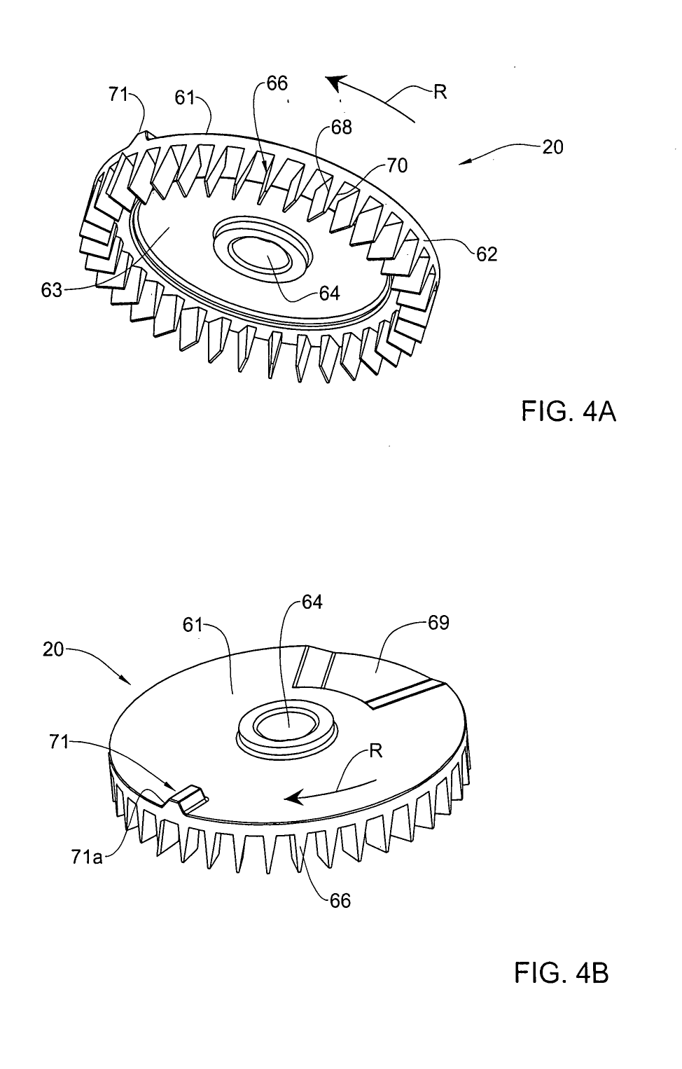

As seen in FIGS. 4A and 4B, the turbine 20 is formed as a disk 62 having upper and lower surfaces 61 and 63 and a centrally located through-going aperture 64. The aperture 64 is sized so as to freely receive therein the shaft 54 of the diverter 18, with the turbine resting on the seat 57 of the shaft's bottom section 55, allowing the turbine to rotate relative to the shaft 54, in a direction indicated by arrow R. The lower surface 63 of the turbine 20 is formed with downwardly projecting blades 66 whose axial extension is such that, when the turbine is mounted on the shaft 54, the blades slightly protrude into the path of fluid leaving the outlets 49 of the diverter. Each blade 66 comprises a leading face 68, which is substantially perpendicular to the disk 62, and a trailing face 70, which forms an angle with the leading face. The blades 66 are oriented such that the trailing faces 70 all face in the same angular direction such as to cause the turbine to rotate when the trailing faces of its blades are impacted by the fluid leaving the diverter via its outlets 49. The upper surface 61 of the turbine is formed with a first drive element or protrusion 71 and a depression 69 located opposite the protrusion. Optionally, a leading edge 71a of the protrusion 71 is angled.

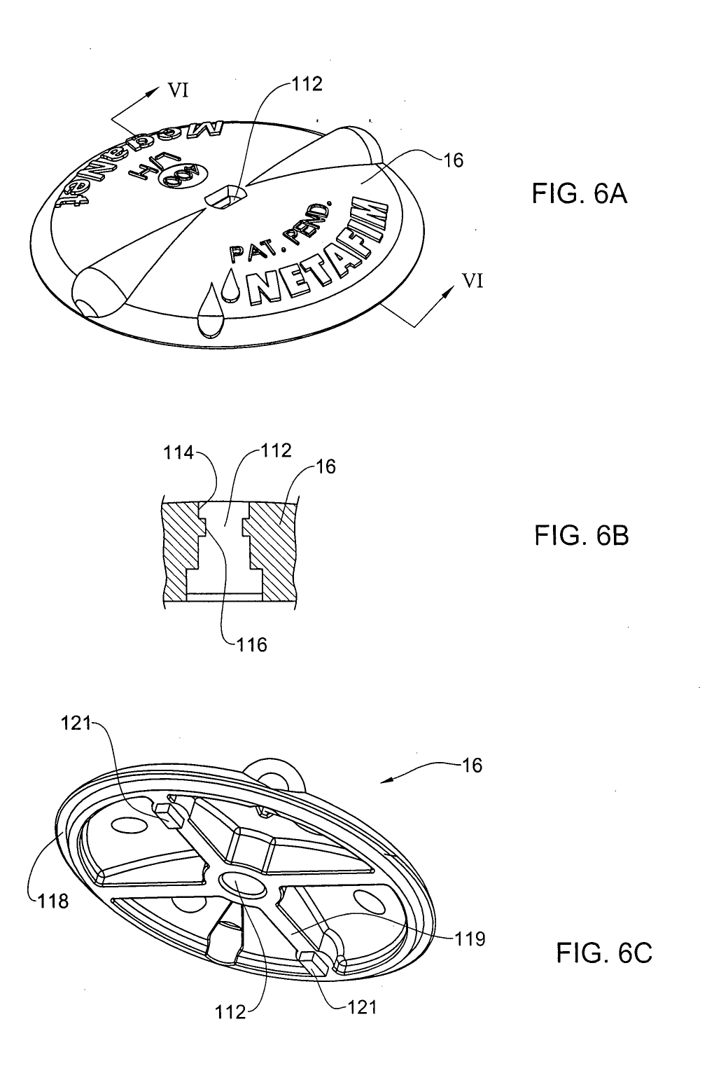

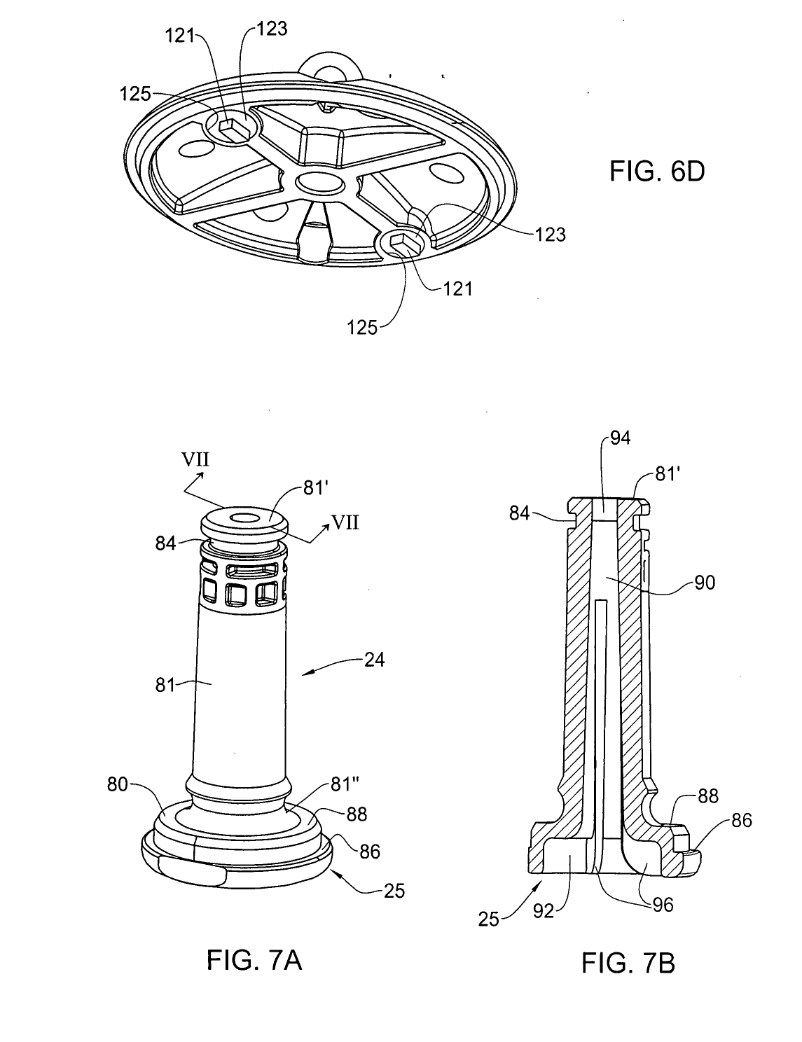

As illustrated in FIGS. 6A and 6B, the cap 16 comprises a centrally located through-going aperture 112. The aperture 112 is formed so as to receive the top section 59 of the shaft 54 of the diverter 18. As such, sides 114 of the aperture 112 are planar, and have projections 116 formed so as to substantially fit within the grooves 60 formed in the shaft. As seen in FIG. 6C, the cap 16 has a bottom surface 119 formed with impact resistant second drive elements or ribs 121 protruding downwardly therefrom so as to be capable of engaging the protrusion 71 on the upper surface 61 of the turbine 20 when the diverter assembly 17 is assembled as shown in FIG. 3B.

It is noted that the ribs 121 of and/or the protrusions 71 may be made of a material which has a higher resistance to impacts than the remainder of the cap or the turbine, respectively. For example, the cap may be made of nylon, and the ribs 121 may be made of TPU. Such a cap may be produced by multi-materials injection molding technology. One example of the aforementioned is shown in FIG. 6D wherein the second drive element 121 and an integral implant 123 thereof are paced in a circular cavity 125 of the cap.

The cap 16 further comprises a notch 118 extending along the circumference of the cap and shaped to suit the seat 101 at the upper end 97 of the upper housing 14, as described with reference to FIG. 9B. The cap 16 has a diameter which is slightly less than that of the upper housing 14 at its upper end 97 to enable the cap to be received within the upper end of the upper housing to form a closed structure with the upper and lower housings when the sprinkler is in its closed position, as seen in FIG. 1A. In the closed position there is no access to an interior of the housing in which an interior mechanism including, inter alia, the nozzle 24, filter 28, and diverter assembly 17 are located. As a result, in the closed position the sprinkler is protected from damage that may occur from insects or other foreign matter such as grit, mud, or the like.

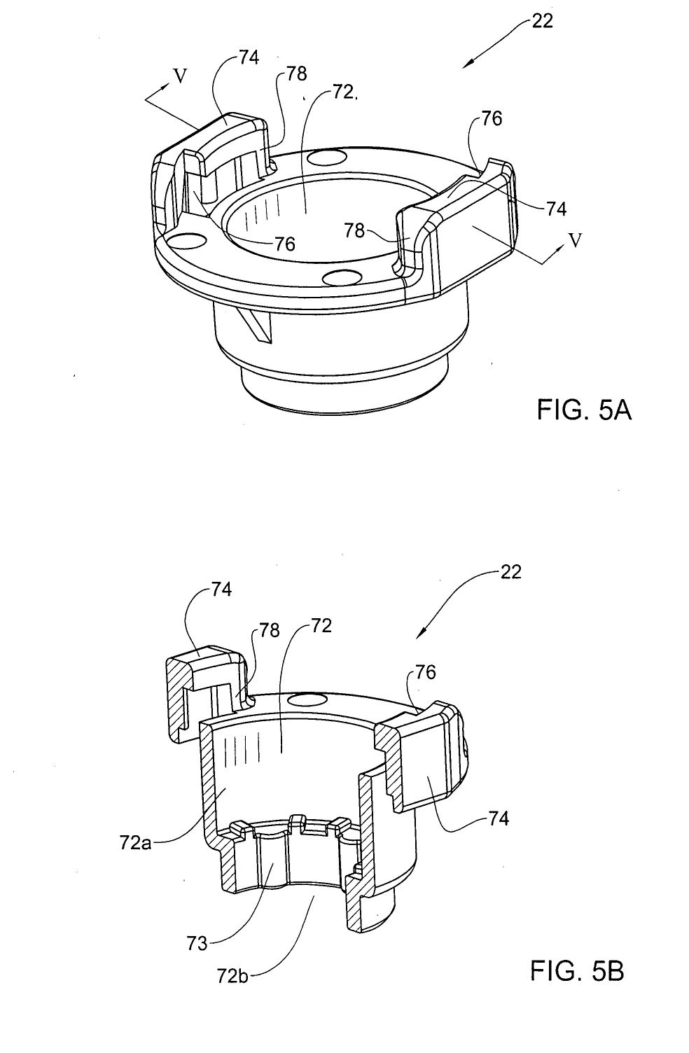

As seen in FIGS. 5A and 5B, the diverter bracket 22 is formed with a through-going bore 72 having upper and lower portions 72a, 72b of two different diameters. The upper portion 72a is sized so as to snuggly receive the lower portion 39′ of the diverter 18 therein. The lower portion 72b comprises several lobes 73 arranged circumferentially, which are together adapted to rotatably receive the tube portion 81 of the nozzle 24. The lower portion 72b and particularly, the lobes 73 adapted for contacting the tube portion 81 of the nozzle 24, have an essential axial extension to prevent the diverter 18 when mounting on the nozzle 24, from being inclined relative to the longitudinal axis X under the influence of radial forces acting on the diverter assembly during its rotation. Such inclination may allow dirt to enter the space between the axially extending contacting surfaces of the lobes 73 and the nozzle. Projecting upwardly from opposite sides of the diverter bracket 22 adjacent the upper portion 72a of the bore 72 are grips 74 adapted to snuggly receive therein the wings 48 of the diverter 18. The grips 74 are open at a trailing end 76 and closed at a leading end 78, and oriented such that when the diverter 18 is placed within the upper portion 72a of the bore 72, the trailing end 76 of each grip 74 faces the leading end 52 of one of the wings 48. It will be appreciated that although FIG. 5B illustrates the transition from the upper portion 72a of the bore 72 to the lower portion 72b as being abrupt, giving rise to a shelf, this is not essential, and the transition may be smooth, for example.

To assemble the diverter assembly 17, the lower portion 39′ of the diverter 18 is fitted within the upper portion 72a of the bore 72 of the diverter bracket 22, such that the leading ends 52 of the wings 48 face the trailing ends 76 of the grips 74. The diverter 18 is then rotated such that the wings 48 are retained within the grips 74. The taper of the wings ensures a tight contact. The shaft 54 of the diverter 18 is guided through the aperture 64 of the turbine 20, and then through the aperture 112 of the cap 16. Due to the slot 56 in the upper end 59 of the shaft 54, this upper end is slightly compressed within the aperture 112 of the cap 16, exerting pressure on the sides 114 thereof. This, in combination with the fitting of the projections 116 of the cap 16 within the grooves 60 of the shaft 54, ensures reliable mounting of the cap 16 on the shaft without the risk that the cap 16 will be unexpectedly hurled from the shaft 54 by the pressure of water therebeneath.

The above operations are preferably performed after the diverter bracket 22 is mounted to the downstream end 27 of the nozzle 24 by the introduction of the downstream end within the lobes 73 of the lower portion 72b of the bore 72 of the diverter bracket 22 and placement of a friction ring 30 over the downstream end of the nozzle and a retaining ring 32 in the groove 84 of the tube portion of the nozzle (rings 30, 32 are shown in FIGS. 2A, 2B). Before such mounting, the nozzle 24 is mounted in the nozzle supporting section 109 of the upper housing 14 as follows (best seen in FIGS. 2C and 9C). An O-ring 34 of the sprinkler is placed on the inner seat 88 of the nozzle 24, and a spring 26 of the sprinkler (best seen in FIG. 2C) is placed on the outer seat 86 thereof. The nozzle 24 is guided through the aperture 104 at the nozzle supporting section 109 of the upper housing 14 such that the curved sides 106′ of the nozzle supports 106 encompasses the tube portion 81 of the nozzle and the spring 26 is received within the circumferential channel 110 thereof. The retaining ring 32 mentioned above functions to retain the nozzle within the aperture 104 and the bore 72 against the force of the spring 26.

The open end of the filter 28 is then mounted on the collar 105 of the nozzle supporting section 109, by squeezing the collar's outmost wall 119 into the open top 33 of the filter 28 until the open top 33 abuts the transition stem 107 between the nozzle spacing section 103 and the nozzle supporting section 109. The lower housing 12 is then attached to the upper housing 14.

In operation, water having a local water pressure at the location of the sprinkler along the water source enters the lower housing as indicated by arrow A in FIG. 2A. It passes through the filter 28 and then impacts and exerts an upwardly-directed pressure on the base portion 80 of the nozzle 24, thereby forcing the nozzle upward into the raised position and the diverter assembly into an operative position, as illustrated in FIG. 2B. Optionally, a local water pressure in the range of 1 to 5 meters above atmospheric pressure is sufficient to urge the nozzle into its raised position.

When the nozzle 24 is fully upward, the spring is fully compressed and the O-ring 34 is pressed between the inner seat 88 of the nozzle and the flange 108 of the nozzle supporting section 109 of the upper housing 14. The O-ring in this position both seals the aperture 104, ensuring that all water exits via the nozzle, and provides axial support for the nozzle 24 in its raised position.

As described above, the diverter assembly rotates about the axis during operation thereby allowing the nozzle to remain static. By virtue of fact that the nozzle is in a rotationally static state during operation of the sprinkler (i.e., it does not rotate about the longitudinal axis, but may move in other directions), the O-ring is not damaged by friction that would otherwise have been imposed thereupon by the flange or nozzle during rotation. This protection of the O-ring maintains the sealing of the aperture 104 during operation of the sprinkler. The rotationally static state of the nozzle during operation also prevents damage to the spring when it is fully compressed between the nozzle and the housing. As will be described below, the spring has a biasing function which may be damaged over time if the nozzle were not rotationally static.

It will be appreciated that due to the design of the nozzle holding portion 100 of the upper housing 14, the flange 108 is axially reinforced by the walls 111 and 119, and further by the entire nozzle spacing section 103 extending substantially along the axis X, whereby the axial support provided to the nozzle 24 by the flange 108 may be sufficient to withstand essential axial forces. In addition, the bottom end portion 81″ of the tube portion 81 of the nozzle 24 is now snuggly received within the nozzle supports 106 of the collar 105 of the nozzle supporting section 109 providing radial support thereto. It will be appreciated that surfaces providing axial support to the nozzle (i.e., the flange 108 of the upper housing 14) and providing radial support thereto (i.e., the radial supports 106 of the upper housing) are axially and radially spaced from each other, thereby providing a stable support for the nozzle in the nozzle supporting section 109. FIG. 2C illustrated how the nozzle 24 is, in its raised position, supported axially by the flange 108 and walls 111 and 119, and radially by the nozzle supports 106.

With the nozzle 24 in its static raised position as shown in FIGS. 2B and 2C, a large area of the filter 28 is available for the water entering the inlet 92 of the nozzle. In this position, water exits the outlet 94 of the nozzle as an axial jet, and enters the diverter assembly 17, striking the rib 44 of the diverter 18. The water splits into two paths in roughly equivalent proportions, follows the slots 40 along their diverting walls 42 and laterally exits the outlets 49.

A speed control mechanism of the sprinkler is then activated by a portion of the water which laterally exits the outlets and strikes the blades 66 of the turbine 20. Due to the angled trailing face 70 of each blade, motion is imparted to the turbine, which rotates independently, causing the protrusion 71 of the turbine to impact the ribs 121 of the cap 16, imparting a slight rotation to the cap at each impact. The cap, together with the entire diverter assembly therefore rotates at a slower rotational rate than the turbine. When the protrusion 71 impacts the rib 121, the turbine 20 tilts such that the side which impacts the rib is lowered. The depression 69 thus accommodates a portion of the cap 16 within the raised side of the turbine 20, preventing that side of the turbine from impacting the cap 16 and interfering with the rotation thereof. The reduced rotational speed of the diverter assembly extends the maximum extent of the laterally distributed water thereby enabling a larger area to be covered.

When the water supply to the sprinkler 10 is terminated, the spring 26 serves as a biasing mechanism which urges the nozzle 24 into its lowered position, thereby bringing the diverter assembly 17 into its retracted, inoperative position, as illustrated in FIG. 2B. The notch 118 of the cap 16 is received within the seat 103 of the upper housing 14, such that no portion of the cap protrudes laterally from the upper end 97 of the upper housing 14. Gaps between the nozzle supports 106 of the upper housing 14 allow water and/or dirt which may have accumulated therein to be washed away. In addition, the gaps reduce friction between the nozzle 24 and the nozzle supporting portion 109 thereby allowing the nozzle to rise to its raised position under lower water pressure.

Whilst the spring has been described with reference to the biasing mechanism, it will be understood that the disclosure is equally applicable to sprinklers employing other resilient biasing mechanisms such as rubber or the like which may provide the biasing effect.

Attention is now drawn to FIGS. 10A and 10B. In an embodiment of the disclosure, the sprinkler 10 may be mounted in a given location in an open field on a riser 130 which is stuck in the ground 132 and thereby positions the full body of the sprinkler 10 above a ground face 133 and in a vertical orientation wherein the axis of the sprinkler is generally upright in relation to the ground face. In operation (FIG. 10B), the water pressure supplied to the sprinkler from the hose 134 urges, inter alia, the diverter assembly into its operative position together with the cap thereby opening the closed structure of the sprinkler. In this position, the laterally directed fluid 136 irrigates the open field. As already described in detail hereinabove, when the sprinkler is not in operation (FIG. 10A), the biasing mechanism urges the diverter assembly to retain its inoperative position wherein the cap and the housing regain the closed structure of the sprinkler.

After irrigating the given location in the open field, the riser may be released from the ground and laid together with the sprinkler in a generally horizontal orientation upon the ground face for a period of time before being relocated to a new location. During this period of time, the closed structure of the sprinkler, which is maintained in its closed position by the biasing mechanism, protects the interior of the housing by ensuring that dirt and the like do not enter into the housing.

Thus a long felt need for a protection of an interior mechanism of a sprinkler which is adapted to be mounted above ground face is met. The sprinkler is of the type which employs a speed control mechanism and is adapted to rise to an open position at an inlet water pressure in the range of 1 to 5 meters above atmospheric pressure.

Those skilled in the art to which this invention pertains will readily appreciate that numerous changes, variations and modifications can be made without departing from the scope of the invention mutatis mutandis.

### LIST OF REFERENCE NUMERALS

sprinkler 10
   longitudinal axis X
   inlet end 2
   outlet end 4
   housing assembly 11
      lower housing 12
         lower portion 120
            first external threading 124
         upper portion 122
            second external threading 126
         external groove 127
      upper housing 14
         outer mounting portion 98
            narrow lower end 95
            internal threading 102
            wide upper end 97
            a rim 99
            seat 101
         inner nozzle holding portion 100
            nozzle spacing section 103
            nozzle supporting section 109
            nozzle receiving aperture 104
            collar 105
            innermost wall 111
            nozzle supports 106
            curved sides 106′
            intermediate wall 113
            flange 108
            groove 117
            outermost wall 119
            circumferential channel 110
            transition step 107
   nozzle 24
      upstream end 25
      downstream end 27
      base portion 80
         outer seat 86
         inner seat 88
      tube portion 81
         top end portion 81′
            groove 84
         bottom end portion 81″
      fluid passageway 90
         inlet 92
         outlet 94
         ribs 96
   filter 28
      a bottom wall 29
      side wall 31
      top 33
      axial slots 35
      circumferential grooves 37
   diverter assembly 17
      diverter 18
         diverter body 39
            lower end 39′
            inlet 41
            slots 40
            diverting walls 42
            central rib 44
            upper end 39″
            outlets 49
            wings 48
            trailing end 50
            leading end 52
         shaft 54
            bottom section 55
            seat 57
            top section 59
            slot 56
            side surfaces 58
            cap engaging groove 60
      diverter bracket 22
         through-going bore 72
            upper portion 72a
            lower portion 72b
            lobes 73
            grips 74
            trailing end 76
            leading end 78
      turbine 20
         disk 62
            upper surface 61
            depression 69
            protrusion 71
            leading edge 71a
            lower surface 63
            blades 66
            leading face 68
            trailing face 70
            aperture 64
      cap 16
         aperture 112
            sides 114
         bottom surface 119
            impact resistant ribs 121
         notch 118
   O-ring 36
   friction ring 30
   retaining ring 32
   spring 26

1. A rotary sprinkler having a longitudinal axis and comprising:
a housing comprising an upper housing and a lower housing;
a nozzle adapted for being brought into fluid communication with a water source and to produce an axial water jet, said nozzle being movable along the axis between a lowered position and a raised position; and
a diverter assembly adapted for receiving said water jet from the nozzle and laterally redirecting it, said diverter assembly being movable along the axis with said nozzle between respective inoperative and operative positions of the diverter assembly,
wherein said upper housing comprises a nozzle supporting section providing the nozzle with a radial support and an axial support, at least when it is in its raised position.

2. A rotary sprinkler according to claim 1, wherein the upper housing comprises an upper end and a lower end, said lower end being adapted for mounting of the upper housing on the lower housing, said upper housing further comprising a nozzle spacing extending inwardly and downwardly from the upper end and holding the nozzle supporting section within the lower housing.

3. A rotary sprinkler according to claim 1, further comprising a cap movable between an open position of the sprinkler, associated with the operative position of the diverter assembly axially protruding from the upper housing, and a closed position of the sprinkler, associated with the inoperative position of the diverter assembly being received within the upper housing, wherein it covers an open upper end of the upper housing thereby preventing access to the diverter assembly in its inoperative position and the nozzle in its lowered position, the upper housing comprising a seat adapted, at least when the sprinkler is in its closed position, to prevent any part of the cap from projecting laterally from the upper end of the upper housing.

4. A rotary sprinkler according to claim 3, wherein the cap constitutes a part of the diverter assembly and is movable therewith.

5. A rotary sprinkler according to claim 1, wherein said radial and axial supports are provided at locations spaced from one another.

6. A rotary sprinkler according to claim 1, wherein said nozzle supporting section of the upper housing comprises an aperture for receiving the nozzle, such that inner walls of said aperture provide the nozzle with radial support.

7. A rotary sprinkler according to claim 6, further comprising a collar surrounding said aperture adapted to provide the nozzle with axial support.

8. A rotary sprinkler according to claim 1, further comprising a biasing mechanism adapted for causing a movement of the nozzle from its raised position to its lowered position when no axial force is applied thereto sufficient to bring it to the raised position.

9. A rotary sprinkler according to claim 1, wherein said nozzle has an upstream end and a downstream end, said diverter assembly adapted to rotate about the axis and being rotatably mounted to at least the upstream end of said nozzle, said nozzle and diverter assembly having axially extending contacting surfaces.

10. A rotary sprinkler according to claim 1, wherein said diverter assembly comprises:
a rotatable diverter adapted for receiving the axial stream of water and laterally redirecting it;
a turbine adapted to rotate independently of the diverter and comprising blades positioned to be impacted by at least a portion of the redirected stream of water, and a first drive element; said blades being formed such that, when they are impacted by the stream, a rotational force is imparted to the turbine; and
a cap adapted to rotate with the diverter and comprising a second drive element positioned so as to be engaged by the first drive element upon rotation of the turbine;
wherein at least one of the following is true:
(a) the material of the first drive element is different from, and better adapted to withstand impacts than, the material of the turbine; and
(b) the material of the second drive element is different from, and better adapted to withstand impacts than, the material of the cap.

11. A rotary sprinkler having an axis comprising:
a housing comprising an upper housing and a lower housing;
a nozzle adapted for being brought into fluid communication with a water source and for producing an axial water jet; and
a diverter assembly adapted to receive said water jet and to laterally redirect it, wherein said upper housing comprises an outer, mounting portion having an upper end and a lower end, said lower end being adapted for mounting the upper housing on the lower housing, the upper housing further comprising an inner, nozzle holding portion, extending inwardly and downwardly from the upper end of the outer portion and having a nozzle supporting section located within the lower housing for axially and radially supporting the nozzle.

12. A rotary sprinkler according to claim 11, wherein said nozzle supporting section of the upper housing comprises an aperture for receiving the nozzle, such that inner walls of said aperture provide the nozzle with radial support.

13. A rotary sprinkler according to claim 12, further comprising a collar surrounding said aperture adapted to provide the nozzle with axial support.

14. A rotary sprinkler comprising:
a housing having an open upper end and a lower end;
a nozzle adapted for being brought into fluid communication with a water source via said lower end and for producing an axial water jet, the nozzle being movable between a lowered position and a raised position;
a diverter assembly axially movable with said nozzle assembly into the diverter assembly's respective inoperative position in which it is received within said housing, and operative position in which it projects upwardly from said open end of the housing; and
a cap movable between an open position, associated with the operative position of the diverter assembly and the raised position of the nozzle, and a closed position, associated with the inoperative position of the diverter assembly and the lowered position of the nozzle;
wherein the cap, in its closed position, covers the upper open end of the housing thereby preventing access to the diverter assembly in its inoperative position and the nozzle in its lowered position, the housing further comprising a seat formed adjacent said upper end thereof adapted, at least when the cap in its closed position, to prevent any part of the cap from projecting laterally from a top surface thereof.

15. A rotary sprinkler according to claim 14, wherein the cap constitutes a portion of the diverter assembly.

16. A rotary sprinkler having an axis and comprising a housing and a nozzle having an upstream end and a downstream end and adapted for being brought into fluid communication with a water source and to produce an axial water jet, and a diverter assembly adapted to rotate about the axis and being rotatably mounted to at least the upstream end of said nozzle and to laterally redirect said water jet, said nozzle and diverter assembly having axially extending contacting surfaces.

17. A diverter assembly for use in a rotary sprinkler, said diverter assembly comprising:
a rotatable diverter adapted for receiving an axial stream of water and laterally redirecting it;
a turbine adapted to rotate independently of the diverter and comprising blades positioned to be impacted by at least a portion of the redirected stream of water, and a first drive element; said blades being formed such that, when they are impacted by the stream, a rotational force is imparted to the turbine; and
a cap adapted to rotate with the diverter and comprising a second drive element positioned so as to be engaged by the first drive element upon rotation of the turbine;
wherein at least one of the following is true:
(a) the material of the first drive element is different from, and better adapted to withstand impacts than, the material of the turbine; and
(b) the material of the second drive element is different from, and better adapted to withstand impacts than, the material of the cap.

18. A diverter assembly according to claim 17, wherein the material of said cap comprises nylon and the material of said second drive element comprises a thermoplastic polyurethane elastomer.

19. A diverter assembly according to claim 18, wherein said nylon comprises glass fibers.

20. A rotary sprinkler adapted to be fully positioned above a ground face, the sprinkler comprising a biasing mechanism and a closable housing defining therein an interior, said sprinkler being adapted to assume an open position in an operative state thereof and a closed position in an inoperative state thereof, wherein access to the interior is prevented, in the inoperative state and the biasing mechanism is adapted to bring the sprinkler into its closed position.

21. A rotary sprinkler according to claim 20, adapted to be mounted on a riser above the ground face.

22. A rotary sprinkler according to claim 20, further comprising a speed control mechanism.

23. A rotary sprinkler according to claim 20, being adapted to be brought into flow communication with a water source at a local water pressure, said local water pressure being sufficient to urge the sprinkler to assume the open position in the operative state.

24. A rotary sprinkler according to claim 23, adapted to assume the open position when in fluid communication with a local water pressure of or greater than 1 meter above atmospheric pressure.
